(19) United States
(12) Patent Application Publication
(10) Pub. No.: US 2002/0087445 A1
(43) Pub. Date: Jul. 4, 2002

(54) Financial processing systems and methods

(75) Inventors: Yoshiyuki Kaniwa, Toyonaka-shi (JP); Kazuhisa Takeuchi, Suita-shi (JP); Kazuyori Yamamori, Toyonaka-shi (JP)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/003,954

(22) Filed: Oct. 31, 2001

(30) Foreign Application Priority Data
Dec. 14, 2000 (JP) 2000-380198

(51) Int. Cl. G06F 17/60

(52) U.S. Cl. 705/35

(57) ABSTRACT

A database system that can analyze multichannel data multilaterally so as to total data items and satisfy various detailed conditions. The system includes: a data storage unit 50 for storing data; a data base management unit for managing input/output of data to/from this data storage unit; a data processor for controlling the data base management unit to obtain predetermined data from the data storage unit and process the data; and a stored function 40 enabled to define a field value used to group data. The data processor is used to enter an execution command that specifies the stored function to be used in a data processing so as to instruct the data base management unit to total data items according to the field value defined by the stored function specified in the execution command.

### BACKGROUND OF THE INVENTION

1. Field of the Invention

The present invention relates to a method and system for analyzing multichannel data such as a loan management data base multilaterally and outputting the analysis result.

2. Related Art

A loan such as a housing loan is usually analyzed by a well-known method for totaling and analyzing accumulated information on the loan by issuing queries (hereinafter, to be referred to as SQL queries) described in the Structured Query Language (SQL) to an information system configured mainly by a relational data base (RDB).

Generally, however, high-level knowledge is required to reply to those SQL queries when assembling complicated SQL queries used for such a highly advanced analysis. In addition, an interactive guidance mechanism has been used to support creation of such SQL queries.

To total some data items, the ‘how to group’ keys used for grouping those data items is important.

When a field consisting of a small number of codes is used as a key for totaling some data items, the GROUP BY statement for SQL queries can be used to total the data items directly. In such a data totaling process, however, there is some data items that must be totaled on such conditions as an area code, a sum of money, etc. Otherwise, the data totaling becomes meaningless. There is also a method effective for totaling data on predetermined conditions. According to the method, a new field is defined on predetermined conditions so as to be used as a key for issuing SQL queries. Conventionally, a multidimensional database (multidimensional DB) for which conditions for totaling data items are set in some layers has been employed to total these data items.

At the time of managing a loan such as a housing loan, a cash flow of a predetermined loan group (a group of loans collected on a predetermined standard) in the future is usually estimated. One of the well-known methods used for such an estimation is a payback simulation performed on the basis of a loan payback method and an estimation of a fluctuating interest. The simulation is often done by taking estimated rates based on a failure to payback (default) and a payback before the due time.

In a multilateral analysis having superior loan properties including selectable fluid items in a loan securitization, it is required to total data in detail corresponding to the predetermined conditions. For example, the totaling is done when a balance in a totaling processing is totaled in units of 2 million yen, when it is totaled in units of 5 million yen, and when data is grouped in detail only in a predetermined area according to the properties of the area.

Also for object items to be totaled, various other detailed processings are required in addition to statistical values in specific fields. For example, a debt that is delayed in payback more than x months is regarded as a default in a totaling processing and a debt that is delayed in payback more than y months is regarded as a default in another totaling processing. In this way, the rate of the x-month default to the y-month default can be obtained.

In such a case, the conventional method that makes SQL queries by redefining a new field as a multidimensional DB has had to decide the target new field and the hierarchical structure of data in advance. Consequently, the method has taken much labor and time, since the database has had to be reorganized to total the data as described above. Furthermore, according to the conventional technique, the guidance mechanism, as described above, has just been means for supporting creation of SQL query statements, i.e., it has not been effective for redefining the unit of totaling. In addition, the conventional simulation technique has failed in taking into consideration that a debt default and an estimation rate of paybacks before the due time are varied in accordance with detailed conditions such as locality, loan properties, etc. This is the case even when the above-described method that estimates a cash flow of a loan group in the future has been used.

In view of the foregoing, there is a need to provide a database system that can analyze multichannel data multilaterally so as to total data in correspondence to various detailed conditions. There is further need to provide a database system that can simulate a cash flow with addition of properties of data specific to each group obtained in a totaling processing.

### SUMMARY OF THE INVENTION

In order to address the above situation, a first aspect of the invention is directed to a data base system of the present invention manages data so as to total and process the data on predetermined conditions. The system includes: a data storage unit for storing data; a database management unit for managing input/output of data to/from the data storage unit; a data processor for controlling the data base management unit to obtain desired data from the data storage unit and process the data; and a stored grouping function enabled to define a field value used to divide data into groups. The data processor executes program code configured to enter an execution command that specifies the stored grouping function used in a data processing; and program code configured to enter an execution command that specifies said stored grouping function used in a data processing; and program code configured to instruct the data base management unit to total said data according to a field value defined by the stored grouping function specified in the execution command.

Consequently, the system can extract data according to a desired grouping method defined by the stored function. There is no need to redefine any field value when the data base is reorganized.

The data base system of the present invention may also be provided with another stored function in which both condition and method for totaling data are set. The data processor may also be configured to receive an execution command that combines the stored functions for grouping and totaling data and instruct the data base management unit to total up data according to the field value defined by this stored grouping function and on the condition and by the method set respectively in the stored totaling function.

The data processor may also be configured so as to have an asynchronous server that works in the background. The server creates an SQL statement that includes procedures for using both stored functions for grouping and totaling data and instructs the data base management unit to execute this created SQL statement. Furthermore, the system of the present invention may be configured so as to include input means for entering information of a field value defined by a stored grouping function. The data processor creates an SQL statement used to create a stored grouping function according to the information entered via this input means and instructs the data base management unit to execute this created SQL statement.

A second aspect of the invention is directed to the financial data processing system that manages financial data and analyzes the financial data on predetermined conditions. The system includes: a data storage unit for storing financial data; a data base management unit for managing input/output of financial data to/from the data storage unit; a data processor for controlling this data base management unit to obtain desired financial data from the data storage unit and process it; a plurality of stored grouping functions each enabled to define a field value used to divide financial data into groups respectively; and a plurality of stored totaling functions enabled to set both condition and method for totaling financial data respectively. The data processor executes program code configured to specify a stored grouping function selected from a plurality of the stored grouping functions to be used in a data processing and enter an execution command that specifies a stored totaling function selected from a plurality of those stored totaling functions and used in the data processing. The data processor then executes program code configured to instruct the data base management unit to total up data on the condition and by the method set respectively in the stored totaling function according to the field value defined by the stored grouping function.

This financial data processing system may include a first input device for entering field value information defined by a stored grouping function and a second input device for entering information of both condition and method set in the stored totaling function. The data processor may execute program code configured to create an SQL statement used to create the stored grouping function according to the information entered via the first input device; create an SQL statement used to create a stored totaling function according to the information entered via the second input device; and instruct the data base management unit to execute the created SQL statement.

A third aspect of the invention is directed to a financial data processing system that manages financial data to total the financial data on a predetermined condition and calculate a cash flow according to the financial data. The system includes: a data storage unit for storing financial data; a data base management unit for managing input/output of financial data to/from this data storage unit; a data processor for controlling this data base management unit to obtain desired financial data from the data storage unit and calculate the cash flow; and a stored function for defining a field value used to group the financial data. The data processor corrects the calculated cash flow according to the properties of the financial data set in each group defined by the field value defined by the stored function.

The financial data processing system may further include a property information input device for entering property information of financial data for each field value in the stored function. The data processor may execute program code configured to receive financial data property information used to correct the cash flow via the property information input device; to receive an execution command that specifies the stored function corresponding to the financial data property information; and to correct the calculated cash flow according to the property information received via the input device and corresponding to the stored function specified in the execution command. The property information input device can also decide a predetermined setting period and enters the property information in each set period.

A fourth aspect of the invention is directed to a data processing apparatus. This data processing apparatus includes: an input device for entering definition information that includes an original field expression used to group data in an analysis mother data base, definition of a new field value used to group this data newly, including a range in which this new field value is effective; and a data processor connected to a data base management unit of the analysis mother data base and enabled to create an SQL statement used to instruct this data base management unit to create a stored function for setting a field value corresponding to this definition information in case the data base management unit extracts data according to the definition information received via the input device.

A fifth aspect of the invention is directed to a data processing apparatus. This data processing apparatus is provided with an input device for entering definition information that includes a statistical expression used to obtain statistical information from a predetermined data group and an object field expression used to identify a group of data to be extracted; and a data processor connected to a data base management unit of the analysis mother data base and enabled to create an SQL statement used to instruct the data base management unit to create a stored function for limiting data to be extracted when the data base management unit extracts data according to the definition information entered via the input device.

A sixth aspect of the invention is directed to a data processing apparatus. The data processing apparatus is provided with a data processor for calculating a cash flow by obtaining predetermined financial data from an analysis mother data base that stores the financial data; an input device used for entering property information that includes a group key used to identify financial data to be processed, a predetermined setting period, and a property of the financial data set for the group key and the setting period respectively. The data processor corrects a calculated cash flow according to the property information received via the input device.

A seventh aspect of the invention is directed to a data extracting method. The data extracting method includes the steps of: entering an execution command that specifies a first stored function enabled to define a field value used to group data and a second stored function enabled to set both condition and method for totaling the data; creating an SQL statement that describes a processing for totaling data on the condition and by the method set in the second stored function according to the field value defined by the first stored function; and instructing a data base management unit provided with the first and second stored functions to execute the created SQL statement.

An eighth aspect of the invention is directed to a cash flow calculating method for managing financial data to total the financial data and calculate a cash flow according to the financial data totaled. The cash flow calculating method includes the steps of: entering a cash flow calculation command that specifies a stored function enabled to define a field value used to group data and property information of the financial data set for each field value in the stored function; calculating a cash flow according to the command; and correcting the calculated cash flow according to the property information corresponding to the stored function specified in the command.

A ninth aspect of the invention is directed to a computer program product used to enable a computer to execute the data extracting method.

A tenth aspect of the invention is directed to a computer program product used to enable a computer to execute the cash flow calculating method.

### BRIEF DESCRIPTION OF THE DRAWINGS

FIG. 1 is a block diagram of a database system in an embodiment of the present invention;

FIG. 2 is a flowchart for describing procedures for entering and storing analysis attribute definition in an embodiment of the present invention;

FIG. 3 is an input form for information of analysis attribute definition, to be filled in the processing shown in FIG. 2;

FIG. 4 is an SQL statement corresponding to the definition information shown in FIG. 3, generated in the processing shown in FIG. 2;

FIG. 5 is a flowchart for describing procedures for entering and storing an analysis output definition in an embodiment of the present invention;

FIG. 6 is an input form for information of analysis output definition, to be filled in the processing shown in FIG. 5;

FIG. 7 is an SQL statement corresponding to the definition information shown in FIG. 6, generated in the processing shown in FIG. 5;

FIG. 8 is an input form of a totaling command used to total up data in an embodiment of the present invention;

FIG. 9 is a flowchart for describing a procedure for totaling data items in the processings up to a step in which necessary analysis output definition is described in an SQL statement in an embodiment of the present invention;

FIG. 10 is a flowchart for describing a procedure for totaling data items in the processings up to a step in which the SQL statement is executed in an embodiment of the present invention;

FIG. 11 is an SQL statement generated in the processings shown in FIGS. 9 and 10;

FIG. 12 is a result of data totaling, obtained by executing the SQL statement shown in FIG. 11;

FIG. 13 is a flowchart for describing procedures for entering and storing a scenario by property in an embodiment of the present invention;

FIG. 14 is an input form for entering a scenario number, a group key, and a setting period of a scenario by property in an embodiment of the present invention;

FIG. 15 is an input form for entering a property generation rate with respect to an attribute value corresponding to the analysis attribute definition of a scenario by property in an embodiment of the present invention;

FIG. 16 is a flowchart for describing procedures for entering and storing a fluctuating interest scenario in an embodiment of the present invention;

FIG. 17 is an input form for entering scenario information when a fluctuating interest by period is set in an embodiment of the present invention;

FIG. 18 is an input form for entering scenario information when a market interest is set in an embodiment of the present invention;

FIG. 19 is an input form for entering a command for executing a cash flow calculation in an embodiment of the present invention;

FIG. 20 is a flowchart for describing a procedure for cash flow calculation and a sequence of the processings up to obtainment of scenario information and generation of an SQL for obtaining account information in an embodiment of the present invention;

FIG. 21 is a flowchart for describing a procedure for cash flow calculation in an embodiment of the present invention, the flowchart including the processings up to cash flow calculation of each account and correction of the calculation result;

FIG. 22 is a flowchart for describing a procedure for cash flow calculation in an embodiment of the present invention, the flowchart including the processings up to storing of the cash flow of each account; and

FIG. 23 is a software configuration when the data processor is provided with an asynchronous server.

### DETAILED DESCRIPTION OF THE INVENTION

Hereunder, a preferred embodiment of the present invention will be described in detail with reference to the accompanying drawings.

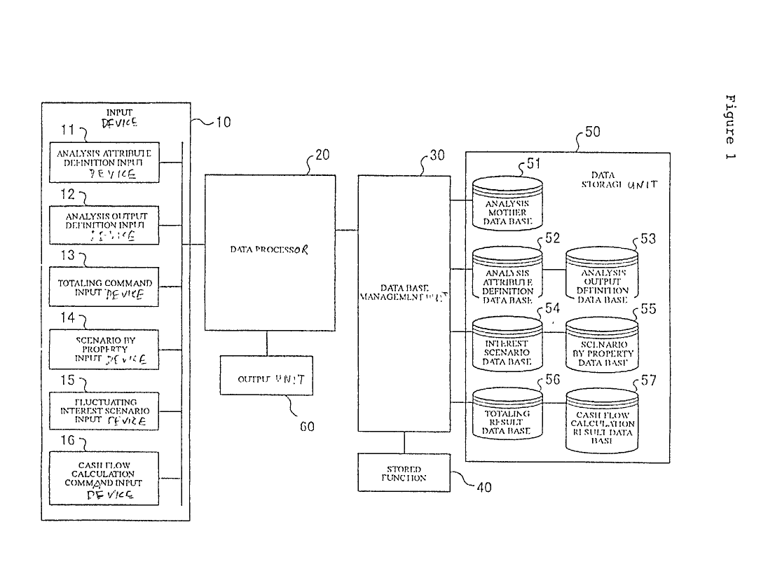

FIG. 1 is a block diagram of a database system in an embodiment of the present invention.

In FIG. 1, the data base system is configured by an input device 10 used to enter various information items and instructions; a data processor 20 used to perform processings such as extracting, analyzing, and totaling of data according to the information and instructions entered via the input device 10; a data base management unit 30 used to manage input/output of data to/from a data base; a stored function (stored procedure) 40 used to support processings performed by the data processor 20 and the data base management unit 30; a data storage unit 50 that includes various data bases dedicated to an application object respectively; and an output unit 60 used to output data processed by the data processor 20.

In the above configuration, the input device 10 is realized by, for example, such input devices as a keyboard, a mouse, etc., a display device used to display an input screen, and an input/output interface. And, according to the type of information to be entered, the input device 10 is provided with analysis attribute definition input device 11; analysis output definition input device 12; totaling command input device 13; scenario input device by property 14; fluctuating interest scenario input device 15; and cash flow totaling command input device 16. Those input devices are set according to the content of each data processing to be described later. Consequently, it is not necessarily required to prepare all those input devices shown in FIG. 1 and other input devices may also be added so as to perform a predetermined data processing.

The data processor 20 is realized by, for example, a CPU, a RAM, and other memories controlled by a program product respectively. The data processor 20 in this embodiment requests the data base management unit 30 and the stored function 40 to perform processings such as extracting and processing of data according to inputs from the input devices 11 to 16 of the input device 10 and receives the results so as to perform processings such as analyzing and processing of them. The data processor 20 creates an SQL statement according to an input from each of the input devices 11 to 16 of the input device 10 and instructs the data management unit 30 to execute this SQL statement so as to obtain a desired processing result. The data processor 20 also specifies the use of a stored function 40 in this SQL statement as needed. The processings such as creating of the SQL statement and processing of the obtained data by the data processor 20 will be described later more in detail.

The data base management unit 30 is realized by, for example, a CPU, a RAM, and other memories controlled by a program product, respectively. The data base management unit 30 receives a request from the data processor 20 so as to extract data corresponding to the received request and returns the data to the data processor 20.

The stored function 40 is a program module registered in the data base management unit 30 and enabled to support the processings of the data base management unit 30. The stored function 40 helps the data base management unit 30 control the input/output of data to/from a data storage unit 50 and perform other processings such as editing and totaling of extracted data as needed.

In the above configuration, a computer program product that controls the CPU so as to execute the functions of the data processor 20 and the data base management unit 30 can be stored in such a recording medium as a CD-ROM, a floppy disk or transmitted so as to be supplied to the user via a network. The data storage unit 50 can be realized by, for example, a semiconductor memory and a magnetic recording device. According to the type of data to be stored, the data storage unit 50 is also provided with an analysis mother data base 51; an analysis attribute definition data base 52; an analysis output definition data base 53; an interest scenario data base 54; a scenario data base by property 55; a totaling result data base 56; and a cash flow calculation result data base 57. The analysis mother data base 51 is always prepared so as to store a master set (a master data group) of data to be processed, but other data bases are prepared according to the content of the data processing to be described later. Consequently, it is not required necessarily to prepare all the data bases illustrated and other data bases may also be added so as to store data generated by a predetermined data processing.

The output unit 60 is realized by such output devices as a display device and a printer, as well as an input/output interface. The output unit 60 outputs results of data processings executed by the data processor 20. The output unit 60 may be configured so as to output results of data processings to an external device via a network.

Next, the processes of the invention will be described. The processes are those executed for a loan analysis with use of the data base system described above. They are the following six types of processes.

1. Entering and Storing Analysis Attribute Definition

2. Entering and Storing Analysis Output Definition

3. Totaling Data

4. Entering and Storing a Scenario by Property

5. Entering and Storing a Fluctuating Interest Scenario

6. Calculating a Cash Flow

In these processes, the data in the process 3 above is totaled with use of the stored function 40 entered in processes 1 and 2 with respect to an analysis attribute definition and analysis output definition. A cash flow is calculated in process 6 with use of a stored function 40 entered in processes 4 and 5 with respect to a scenario by property and a fluctuating interest scenario, as well as a stored function 40 entered in process 1 with respect to analysis attribute definition.

Hereinafter, the operation of this embodiment will be described with respect to each of these processes.

1. Entering and Storing Analysis Attribute Definition

“Analysis attribute definition” means a definition of a data attribute in data analysis, that is, a definition of a field value as an object of totaling/grouping of data.

To analyze data in the master data group stored in the analysis mother data base 51 in the data storage unit 50, it is required to create a field of a data base according to the attribute of the data to be analyzed. Therefore, a stored function 40 is created in this process so as to create a new field according to the predetermined definition information.

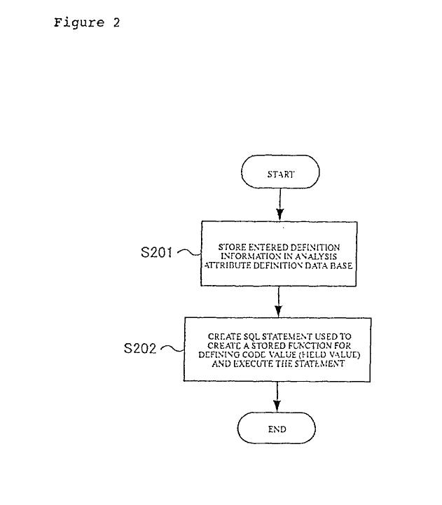

FIG. 2 is a flowchart for describing procedures for entering and storing analysis attribute definition.

As an initial operation, the analysis attribute definition input means 11 of the input unit 10 enters definition information of a field value used to create a new field.

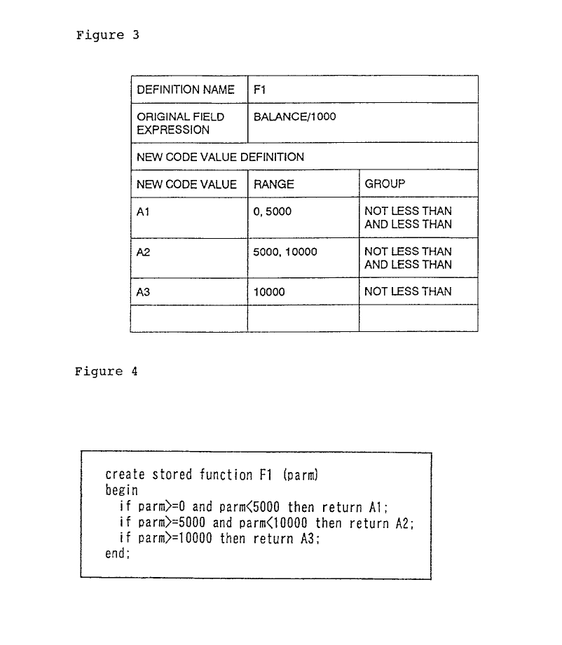

FIG. 3 shows example definition information. The analysis attribute definition input means 11 displays an input form as shown in FIG. 3 on, for example, a display screen to prompt the user to enter necessary definition information. In the example shown in FIG. 3, the definition information items to be entered are: definition name; original field expression; new code value (new field value) definition; and correspondence between the new code value and a range of the new code value (table on correspondence). The original field expression is just required to identify a field in the analysis mother data base 51. Consequently, it may be a field itself, an expression for a field in the analysis mother data base 51, and/or an expression consisting of a plurality of fields as shown in FIG. 3. The table on correspondence between new code value and its range is used to decide a totaling/grouping pattern. When an original field expression is within its specified range, it denotes that the original field expression is related to the corresponding new code value.

The table on correspondence between new code value and its range can specify a boundary condition of the range (whether to take a value over or under the range and whether to take a value less than or more than the value). In the example shown in FIG. 3, three definition items are defined for totaling and grouping. If the balance at the bank is over 0 but less than 5 million (YEN), new code value=Al; over 5 million (YEN) but less than 10 million (YEN), new code value=A2; and over 10 million new code value=A3. (Note that because the balance at the bank is divided by 1000 in the original field expression in FIG. 3, a value that is 1/1000 of the above sum is described in the range column corresponding to each new code value.)

Receiving such definition information, the data processor 20 stores the information in the analysis attribute definition data base 52 via the data base management unit 30 (step 201 in FIG. 2). The data processor 20 then creates an SQL statement used to create a stored function 40 for creating a field corresponding to the subject data analysis and passes the SQL statement to the data management unit 30 so as to be executed there (step 202). Consequently, the created stored function 40 is registered in the data base management unit 30 and used as needed.

FIG. 4 shows an example of such an SQL statement corresponding to the definition information shown in FIG. 3. The SQL statement is generated in the processing shown in FIG. 2. The stored function 40 created by the SQL statement is registered and held in the data base management unit 30. When an execution command (to be described later) received from the data processor 20 includes one argument and the argument satisfies the entered condition, the data base management unit 30 obtains the corresponding new code value from the analysis attribute definition data base 52 and returns the value to the data processor 20. The stored function 40 created by this processing can be used in the subsequent totaling processer so as to define a desired code value (field value) and total the data. According to the stored function 40 created by the SQL statement shown in FIG. 4, the redefined unit of totaling/grouping can be represented by a functional expression of F1 (balance/1000).

2. Entering and Storing Analysis Output Definition

“Analysis output definition” means a definition of both data to be totaled and totaling method.

When a data analysis result is to be output, both data to be totaled and totaling method must be decided before totaling of the analysis results. Therefore, this processing creates a stored function 40 used to identify both data to be totaled and totaling method according to the predetermined definition information.

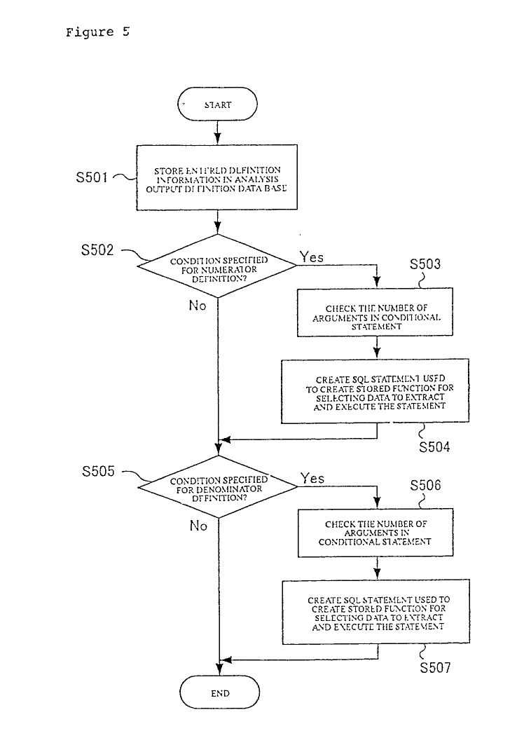

FIG. 5 is a flowchart for describing procedures for entering and storing the analysis output definition.

As an initial operation, the analysis output definition input means 12 of the input unit 10 receives definition information of both data to be totaled and totaling method.

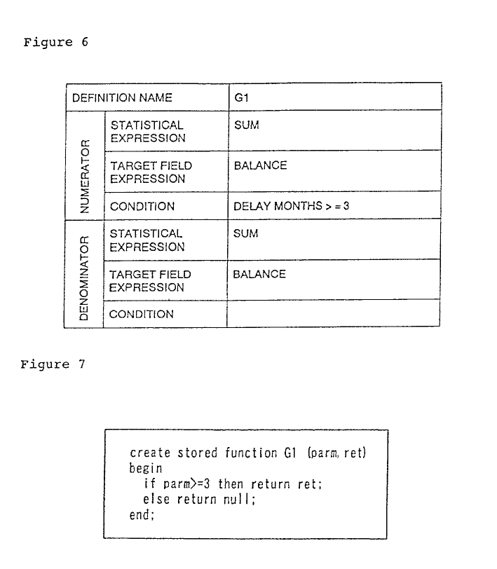

FIG. 6 shows an example of the definition information. The analysis output definition input device 12 displays an input form as shown in FIG. 6 on, for example, a display screen to prompt the user to enter necessary definition information items. In the example shown in FIG. 6, definition information items to be entered are definition name, statistical expression, object field expression, and condition. In this case, calculation of a fractional expression (numerator/denominator) can be made by a combination of a statistical expression, an object field, and a condition. The statistical expression denotes a statistical calculation method used in a group of data to be totaled and grouped. Group functions such as sum, max., min., etc. supplied by the data base management unit 30 are employed for method. The object field expression, just like the original field expression in the analysis attribute definition, may be any of a field itself of the analysis mother data base 51, an expression for a field in the analysis mother data base 51, and/or an expression consisting of a plurality of fields. The condition is specified only when the data selected from the group of data to be totaled and grouped satisfies a predetermined condition. In the example shown in FIG. 6, the condition specifies that a rate of the number of delayed months (more than three months) to the entire balance in each group of totaled/grouped data is calculated.

Receiving such definition information, the data processor 20 stores the information in the analysis output definition data base 53 via the data base management unit 30 (step 501 in FIG. 5). The data processor 20 then performs the following processes.

First, the data processor 20 checks whether a condition is specified in the numerator definition in the numerator/denominator calculation (step 502). If a condition is specified, the data processor 20 checks the number of arguments in the conditional statement (step 503). Then, the data processor 20 generates an SQL statement 1 used to create stored function 40 for performing the following process and passes the stored function 40 to the data base management unit 30 so as to be executed there (step 504) In the stored function 40 created, another new argument is added to the conditional statement obtained in step 502. The added argument is to be returned to the data processor 20. The number of arguments in the conditional statement is thus increased by one more than before. If any data matching with an argument in the conditional statement occurs when the master data group is detected from the analysis mother data base 51, the data base management unit 30 obtains the last argument (added argument) about the data from the analysis output definition data base 53 and returns the argument to the data processor 20. Otherwise, the data base management unit 30 returns Null to the data processor 20.

Similarly, the data processor 20 checks whether a condition is specified in the denominator definition (step 505). If a condition is specified, the data processor 20 checks the number of arguments in the conditional statement (step 506). The data processor 20 then generates an SQL statement 2 used to create a stored function 40 for executing the following process and passes the stored function 40 to the data base management unit 30 so as to be executed there (step 507). In the stored function 40 created, another new argument is added to the conditional statement obtained in step 504. The added argument is to be returned to the data processor 20. The number of arguments in the conditional statement is thus increased by one more than before. If any data matching with an argument occurs in the conditional statement when a master data group is detected from the analysis mother data base 51, the data base management unit 30 obtains the last argument (added argument) with respect to the data from the analysis output definition data base 53 and returns it to the data processor 20. Otherwise, the data base management unit 30 returns Null to the data processor 20.

When no condition is specified in any of the numerator definition and the denominator definition, the data base management unit 30 creates no SQL statement (steps 502 and 505). The stored function 40 created in steps 504 and 507 is registered in the data base management unit 30 and used as needed.

In the above processes, either of the SQL statement 1 for numerator definition (steps 502 to 504) or the SQL statement 2 for denominator definition (steps 505 to 507) may be generated first.

FIG. 7 is an example of an SQL statement corresponding to the definition information shown in FIG. 6, generated in the process shown in FIG. 5. In the analysis output definition shown in FIG. 6, a condition is specified for numerator definition. Thus, the SQL statement corresponds to the definition information. In contrast, no condition is specified for a denominator definition, so no SQL statement is created.

According to the stored function 40 created by the SQL statement shown in FIG. 7, when data does not satisfy a specified condition, the data can be handled as Null, i.e., non-existence in the G1 (the number of delayed months, balance) financial expression. Consequently, the defined totaling can be represented by a functional expression of SUM (G1 (the number of delayed months, balance))/SUM (balance).

3. Totaling of Data

As described above, when an analysis attribute definition that is a totaling/grouping unit and an analysis output definition that is output information are combined in a data totaling command, and analysis attribute definition in data analysis and analysis output definition in analysis result output are defined beforehand, the processing is performed by the stored function 40.

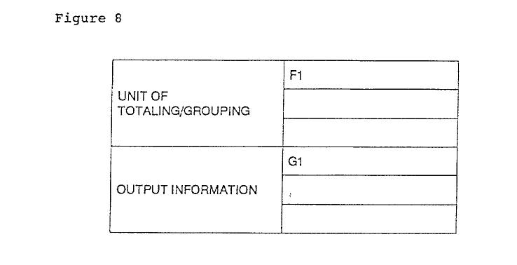

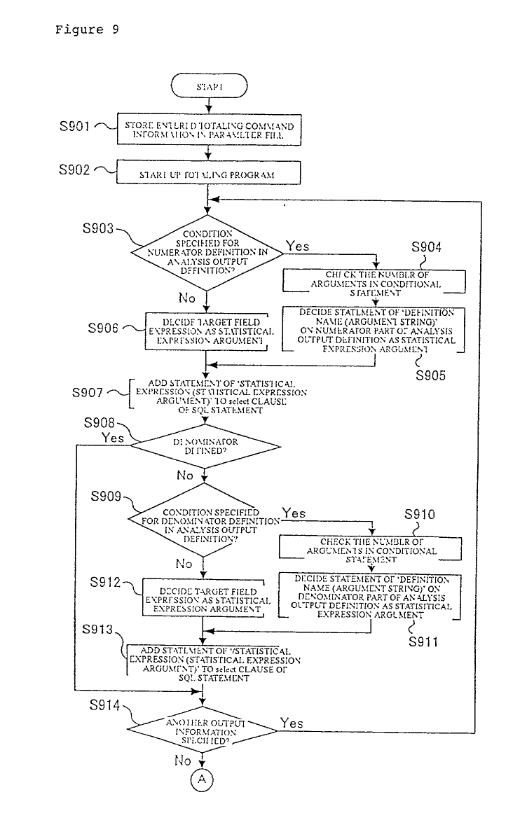

FIG. 8 shows an example of the totaling command information. The totaling command input means 13 of the input unit 10 displays an input form as shown in FIG. 8 on, for example, the display screen to prompt the user to enter necessary information for specifying a unit of totaling/grouping (analysis attribute definition) and output information (analysis output definition). Two or more of both the units (classification) of totaling/grouping and the output information can be specified. When a plurality of units of totaling/grouping are specified, data is totaled for each combination of code values according to the units (classification) of totaling/grouping. In the example shown in FIG. 8, F1 (shown in FIG. 3) is specified as a unit of totaling/grouping and G1 (shown in FIG. 6) is specified as output information respectively.

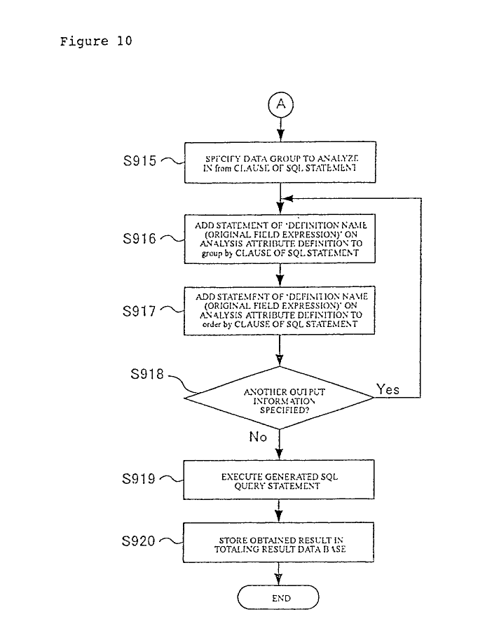

FIGS. 9 and 10 are flowcharts for describing a procedure for totaling data.

As an initial operation, the data processor 20 receives a totaling command via the totaling command input means 13 of the input unit 10.

Receiving the totaling command, the data processor 20 creates a parameter file and stores the unit of totaling/grouping (analysis attribute definition) and the output information (analysis output definition) specified in the totaling command in the parameter file (step 901). The data processor 20 then starts up a program product for totaling subject data (step 902).

The data processor 20 then checks whether a condition is specified for the numerator definition in the analysis output definition (output information) specified in the totaling command under the control of the started-up program product (step 903). When a condition is specified, the data processor 20 checks the number of arguments in the conditional statement (step 904) and decides the ‘definition name (argument)’ statement as a statistical expression argument for the numerator in the analysis output definition that decides the argument and the object field expression in the conditional statement as another argument (step 905). If an analysis output definition is specified here, the use of the stored function 40 created in step 504 (shown in FIG. 5) comes to be described in an SQL statement.

On the other hand, unless a condition is specified for the numerator definition in the analysis output definition, the object field expression is decided as a statistical expression argument (step 906).

After this, the data processor 20 adds a statement of “statistical expression (statistical expression argument)” to the select clause of the SQL statement with use of the statistical expression argument decided in step 905 or 906 (step 907).

Then, the data processor 20 checks whether a denominator is defined for the analysis output definition specified in the totaling command (step 908). If the denominator is defined, the data processor 20 further checks whether a condition is specified for the denominator definition (step 909). If a condition is specified, the data processor 20 checks the number of arguments in the conditional statement (step 910) and decides the statement ‘definition name (argument string)’ as a statistical expression argument with respect to the denominator of the analysis output definition that uses both argument and object field expression in the conditional statement as the arguments (step 911). Because analysis output definition is specified here, the use of the stored function 40 (created in step 507 in FIG. 5) comes to be described in an SQL statement.

On the other hand, when no condition is specified for the numerator definition in the analysis output definition, the object field expression is employed as a statistical expression argument (step 912).

After this, the data processor 20 adds a statement ‘/statistical expression (statistical expression argument)’ to the select clause in the SQL statement with use of the statistical expression argument decided in step 911 or 912 (step 913). The select clause related to the analysis output definition comes to be described as a statement ‘statistical expression (statistical expression argument)/statistical expression (statistical expression argument)’ regarding the relationship of numerator/denominator.

After a select clause is generated with respect to the analysis output definition in the processings up to step 913 or in case no denominator is specified for the analysis output definition at the decision in step 908, then the data processor 20 checks whether another analysis output definition is specified in the totaling command (step 914). If another analysis output definition is specified, the data processor 20 returns to step 903 to generate a select clause with respect to the analysis output definition.

If it is decided in step 914 that a select clause is generated with respect to every analysis output definition specified in the totaling command, then the data processor 20 identifies a data group to be analyzed in the master data group stored in the analysis mother data base 51 and specifies the data group in a “from clause” of the SQL statement (step 915 in FIG. 10). In addition, the data processor 20 then adds a statement ‘definition name (original field expression)’ to a ‘group by’ clause and an ‘order by’ clause in the SQL statement with respect to the analysis attribute definition (unit of totaling/grouping) specified in the totaling command (steps 916 and 917).

After this, the data processor 20 checks whether still another analysis attribute definition is specified in the totaling command (step 918). If another analysis attribute definition is specified, the data processor 20 returns to step 916 so as to generate a ‘group by’ clause and an order by clause with respect to the analysis attribute definition. Consequently, the use of the stored function 40 created in step 202 in FIG. 2 comes to be described in an SQL statement.

If it is decided in step 918 that both ‘group by’ and ‘order by’ clauses are generated with respect to each analysis attribute definition specified in the totaling command, then the data processor 20 passes the generated SQL statement to the data base management unit 30 so as to be executed there (step 919). The data base management unit 30 then stores the data totaled by the SQL statement in the totaling result data base 56 (step 920). The data processor 20 can read the data totaled from the totaling result data base 56 as needed to output it via the output unit 60.

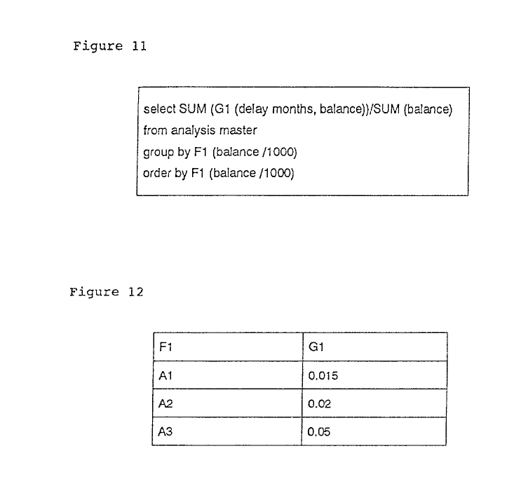

FIG. 11 shows an SQL statement generated by the processings up to step 919 according to the totaling command shown in FIG. 8. FIG. 12 shows data totaled by the SQL statement shown in FIG. 11.

4. Entering and Storing a Scenario By Property

A “scenario-by-property” means estimated data of a change of the value in a predetermined property of each of the analysis attribute definition items and the data base management items (data base items) described above. In this embodiment, the properties are defined as a rate of detected non-fulfillment of financial debts (hereinafter, to be referred to as a default rate) and a rate of detected payments before due time (hereinafter, to be referred to as a rate of paybacks before due time).

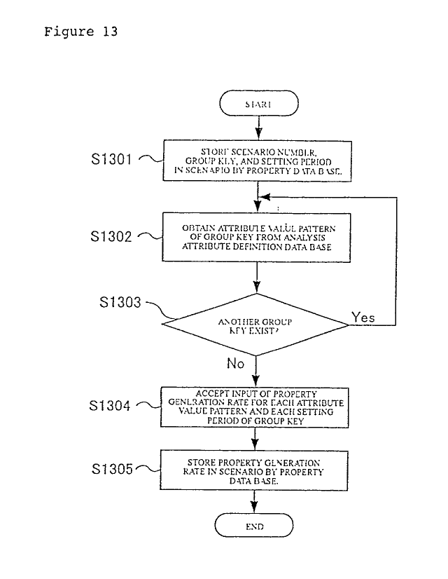

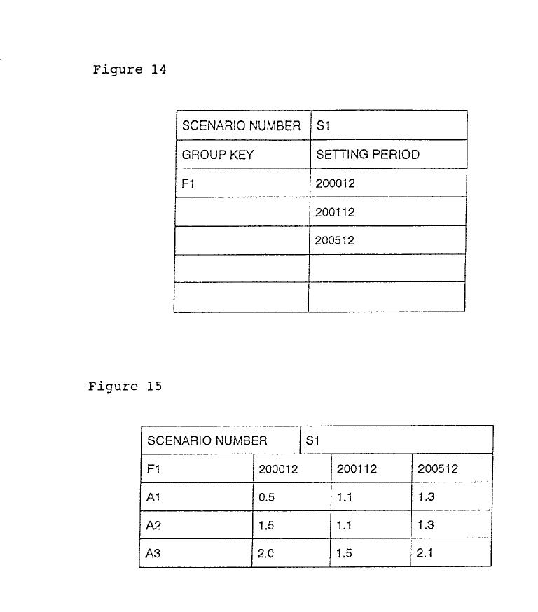

FIG. 13 is a flowchart for describing procedures for entering and storing a scenario-by-property. FIGS. 14 and 15 show input forms for entering scenario information in a scenario-by-property.

As an initial step, the scenario by property input device 14 displays an input form shown in FIG. 14 on the display screen to prompt the user to enter necessary scenario information. In the example shown in FIG. 14, the user is requested to enter a scenario number for identifying a scenario; a group key for analysis attribute definition or data base item whose property change is to be estimated; and a period (setting period) in which a property change should be taken into consideration.

In FIG. 14, analysis attribute definition F1 (shown in FIG. 3) is specified as a group key and three periods of 200012 (December, 2000), 200112 (December, 2001), and 200512 (December, 2005) are specified as the setting periods.

When information is entered for those input items, the data processor 20 stores the information in the scenario-by-property data base 55 (step 1301). Then, the data processor 20 obtains an attribute value pattern of each group key specified by the input information from the analysis attribute definition data base 52 (steps 1302 and 1303).

Obtaining an attribute value pattern of each group key specified in the input information, the data processor 20 displays an input form on the display screen as shown in FIG. 15 to prompt the user to enter scenario information (step 1304). In the example shown in FIG. 15, the user is requested to enter a default rate and a rate of paybacks before due time (property generation rates) that are properties in a table format that uses parameters. The parameters are new code values A1, A2, and A3 (see FIG. 3) that are attribute value patterns in the analysis attribute definition F1 specified by a group key, as well as a setting period. In FIG. 15, it is not shown explicitly whether a property is a default rate or a rate of paybacks before due time, but the user can enter information on the similar input screen so as to create any scenario by property.

When information is entered for each item on the screen, the data processor 20 stores the input information in the scenario-by-property data base 55 (step 1305).

5. Entering/Storing a Fluctuating Interest Scenario

A “fluctuating interest scenario” means estimated data of an interest fluctuation in the future. In this embodiment, there are two scenarios to be defined: a scenario for setting fluctuating interests by period and a scenario for setting market interests.

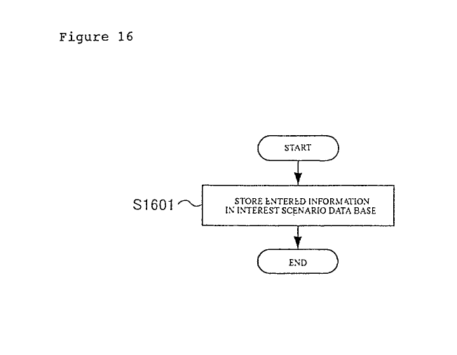

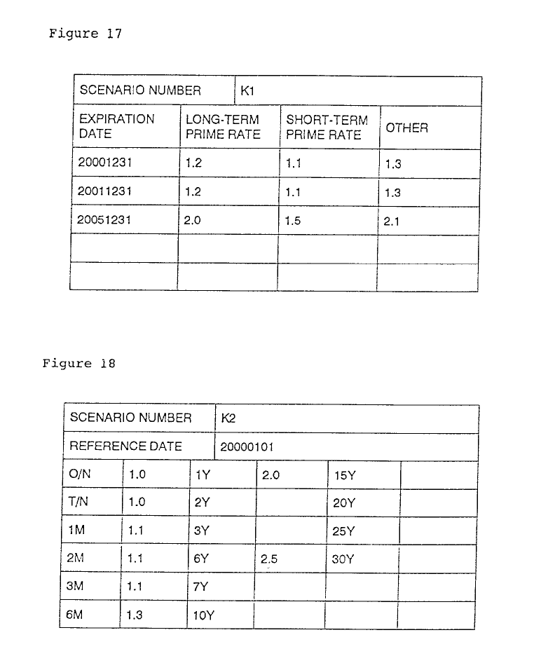

FIG. 16 is a flowchart for describing procedures for entering and storing a fluctuating interest scenario. FIG. 17 shows an input form for entering scenario information to set fluctuating interests by period and FIG. 18 shows an input form for entering scenario information to set market interests.

As an initial step, the fluctuating interest scenario input device 15 displays an input form as shown in FIG. 17 or 18 on, for example, the display screen to prompt the user to enter necessary scenario information. In the example shown in FIG. 17, the user is requested to enter a long-term prime rate, a short-term prime rate, and another interest on each expiration day. In FIG. 17, three expiration days of 20001231 (Dec. 31, 2000), 20011231 (Dec. 31, 2001), and 20051231 (Dec. 31, 2005) are specified and the long-term prime rate, the short-term prime rate, and another interest are entered on each of those expiration days.

In the example shown in FIG. 18, the user is requested to enter an interest in a specific period on a reference day. In FIG. 18, 20000101 (Jan. 1, 2000) is entered as a reference day, and an interest is entered for items: O/N (Over Night), T/N (Tomorrow Next), 1M (1 Month), 2M (2 Months), 3M (3 Months), and 6M (6 Months).

When information is entered for those input items, the data processor 20 stores those input information items in the interest scenario data base 54 (step 1601).

6. Cash Flow Calculation

As described above, because a scenario-by-property and a fluctuating interest scenario are defined beforehand, when a loan group, a totaling level, a scenario-by-property, and a fluctuating interest scenario are specified in a cash flow calculation command as estimation items, the process is executed by the stored function 40.

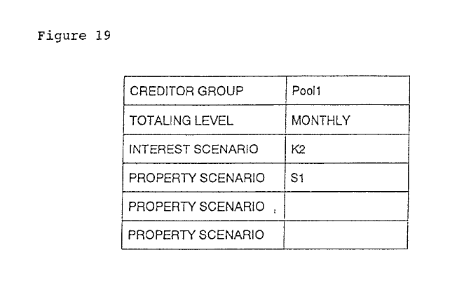

FIG. 19 shows an example of those information items set in the cash flow calculation command. The cash flow calculation command input device 16 displays an input form as shown in FIG. 19 on, for example, the display screen to prompt the user to enter necessary information for specifying a loan group, a totaling level, a scenario-by-property, and a fluctuating interest scenario. The loan group is selected from the master data group stored in the analysis mother data base 51. The totaling level specifies monthly or daily totaling. A plurality of scenarios-by-property can also be specified. In the example shown in FIG. 19, Pool 1 (a data group selected from the master data group) is specified as the loan group, monthly is specified as the totaling level, K2 (shown in FIG. 18) is specified as the fluctuating interest scenario, and S1 (shown in FIG. 15) is specified as the scenario by property, respectively.

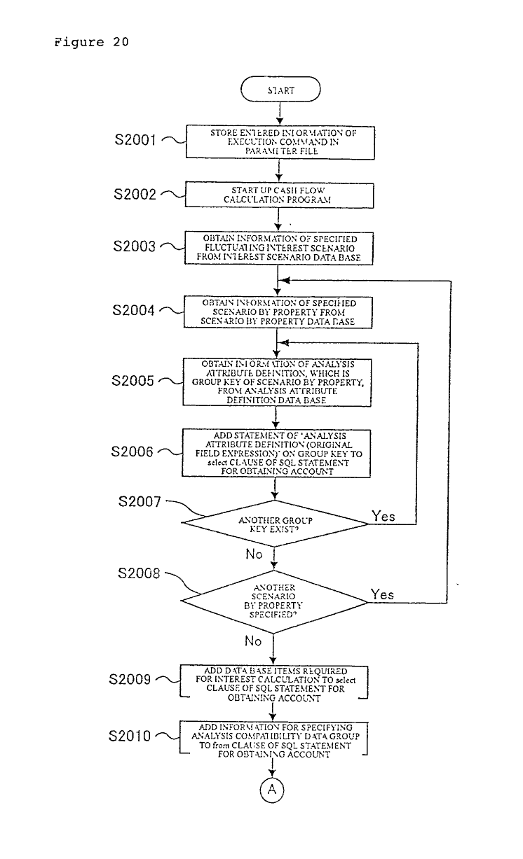

FIGS. 20 through 22 are flowcharts for describing procedures of cash flow calculation.

As an initial step, the data processor 20 receives a cash flow calculation command via the cash flow calculation command input device 16.

Receiving the command, the data processor 20 creates a parameter file and stores a loan group, a totaling level, a scenario-by-property, a fluctuating interest and a fluctuating interest scenario in the parameter file (step 2001). The data processor 20 then starts up a program for calculating a cash flow (step 2002).

Payback simulation is done for calculating the cash flow by taking items of payback method, presence of payback on bonuses, fraction processing, etc., into consideration with respect to each data item of the loan belonging to the specified group, as well as by applying an interest calculated on the basis of the interest scenario to the fluctuating interest application period. At this time, a group to which each loan belongs in the scenario-by-property is checked so as to correct the payback sum, etc. The processes in steps 2003 to 2022 in FIGS. 20 through 22 are executed.

When the program is started up, the data processor 20 obtains information of the fluctuating interest scenario specified by the cash flow calculation command from the interest scenario data base 54 (step 2003) under the control of the started-up calculation program. The data processor 20 then obtains information of the scenario-by-property specified by the cash flow calculation command from the scenario-by-property data base 55 (step 2004). Furthermore, the data processor 20 obtains analysis attribute definition information from the analysis attribute definition data base 52 (step 2005). The information is used as a group key in the scenario-by-property.

After this, the data processor 20 adds a statement ‘analysis attribute definition (original field expression)’ to the select clause of an SQL statement for obtaining account information used for cash flow calculation (step 2006) with respect to each obtained group key. When a plurality of group keys are set in the scenario-by-property, the processes in steps 2005 to 2006 are executed for each of those group keys (step 2007). In case a plurality of scenarios-by-property are specified in the cash flow calculation command, the processings in steps 2004 to 2007 are executed for each of the scenarios-by-property (step 2008). Consequently, the use of the stored function 40 created in step 202 in FIG. 2 and identified by each group key in the scenario-by-property comes to be described in the SQL statement.

The data processor 20 then adds data base items required to calculate an interest used for a cash flow to the select clause of the SQL statement for obtaining account information (step 2009). The data processor 20 then adds information that identifies a data group to be analyzed in the master data group stored in the analysis mother data base 51 to the from clause of the SQL statement for obtaining account information (step 2010).

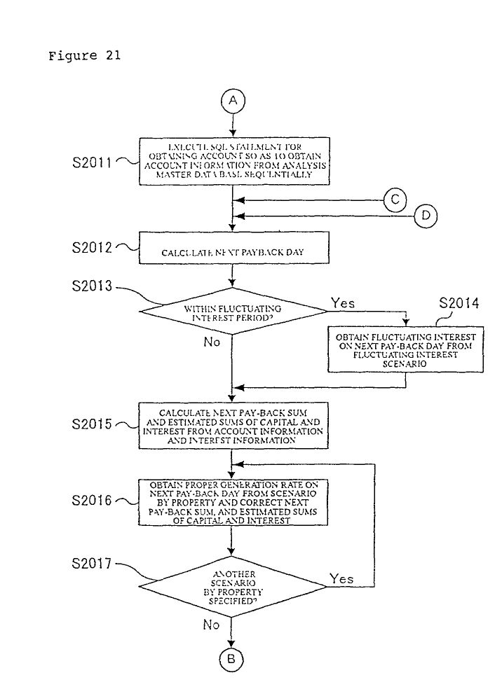

After this, the data processor 20 executes the SQL statement so as to obtain necessary account information items sequentially from the analysis mother data base 51 (step 2011 in FIG. 21).

After this, the data processor 20 calculates the next payback day in each account according to the obtained account information (step 2012). In case the calculated next payback day is within a fluctuating interest period, the data processor 20 obtains the fluctuating interest on the next payback day from the fluctuating interest scenario (steps 2013 and 2014).

After obtaining the fluctuating interest in step 2014, or when the next payback day calculated in step 2013 is not within a fluctuating interest period, the data processor 20 calculates the next payback sum, the capital, and the estimated interest according to the account information and the interest information obtained as described above (step 2015). Furthermore, the data processor 20 obtains a property generation rate (a default rate or rate of paybacks before due time) from the scenario-by-property. The property generation rate corresponds to a combination of group key attribute values in the scenario-by-property obtained as unit of the account information and to the next payback day. The data processor 20 then corrects the next payback sum, the capital, and the estimated interest described above according to the obtained scenario generation rate (step 2016). In case a plurality of scenarios-by-property are specified in the cash flow calculation command, the processing in step 2016 is executed for each scenario-by-property as this correction processing (step 2017).

While means for correcting sums of payback, etc. is used as the correcting method in this embodiment, it is also possible to use a method for simulating a default and a payback before due time of each loan data actually with use of random numbers.

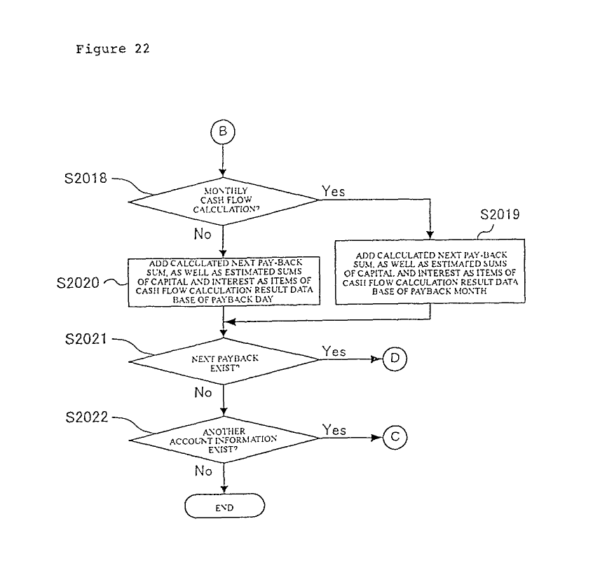

Next, the data processor 20 checks whether monthly totaling is specified or daily totaling is specified as a totaling level in the cash flow calculation command (step 2018 in FIG. 22). In case monthly totaling is specified, the data processor 20 adds the calculated next payback sum, the capital, and the estimated interest to the cash flow data base items of the payback month (step 2019). In case daily totaling is specified, the data processor 20 adds the calculated next payback sum, the capital, and the estimated interest to the cash flow data base items of the payback day (step 2020).

After this, the data processor 20 checks whether there is a next payback scheduled. If the decision is YES, the data processor 20 returns to step 2012 to repeat the above processes for the next payback (step 2021). The data processor 20 also checks whether there is another account. If the decision is YES, the data processor 20 returns to step 2012 to repeat the above processes for the account (step 2022). The data processor 20 then stores the calculated cash flow in the cash flow calculation result data base 57. The data processor 20 reads the calculated cash flow from the cash flow calculation result data base 57 as needed and outputs it via the output unit 60.

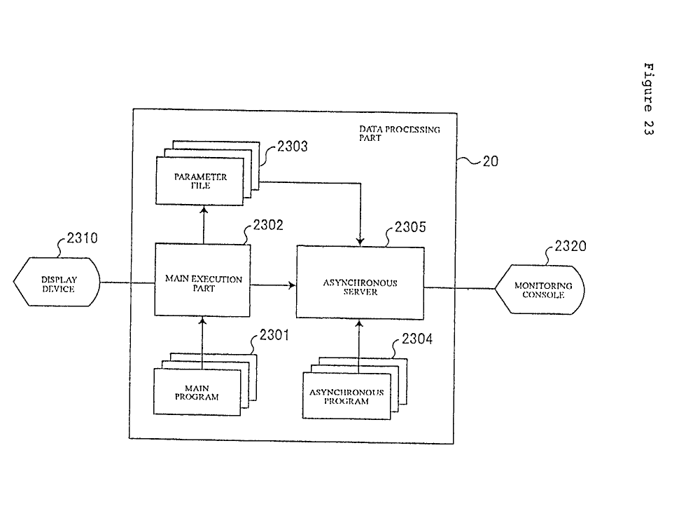

Of the processings described above in this embodiment, data totaling and cash flow calculation should preferably be executed asynchronously, since they take much time. FIG. 23 shows an example of the software configuration when the data processor 20 is provided with an asynchronous server that executes the above processings asynchronously.

In FIG. 23, the data processor 20 that executes the data processes described above has the following software configuration: a main program 2301, a main execution unit 2302 that executes the main program 2301 in real time, a parameter file 2303 that holds information specified in each execution command for data totaling and cash flow calculation, an asynchronous program 2304 to be executed in the background, and an asynchronous server 2305 that executes the asynchronous program 2304 in the background of the processing executed by the main execution unit 2302. The processing executed by the main execution unit 2302 in real time is monitored by the display device 2310 and the operation of the asynchronous server 2305 is monitored by the monitoring console 2320.

In the above configuration, the main program 2301 controls the main execution unit 2302 to control the input devices 11 to 16, writes the information specified in each entered execution command in the parameter file 2303, and outputs the totaling result. The asynchronous program 2304 controls the asynchronous server 2305 to create SQL statements for totaling data and calculating a cash flow as described above, sends those created SQL statements to the data base management unit 30, and corrects the calculated cash flow.

The main execution unit 2302 requests the asynchronous server 2305 to execute a process through socket communication in response to an execution command entered via the input unit device 10. At this time, the main execution unit 2302 passes a file name of the parameter file 2303 that holds the specified information as a parameter to the asynchronous server 2305. The asynchronous server 2305 then starts up the asynchronous program 2304 corresponding to the requested processing as a thread. The asynchronous server 2305 then reads the specified data from the corresponding parameter file 2303 according to the parameter received from the main execution unit 2302 to start the execution. In case this series of processings are done normally, the asynchronous server 2305 reports the start of the processing to the main execution unit 2302, whereby the socket communication is terminated. After this, the asynchronous server 2305 monitors the execution and outputs the monitoring result to the monitoring console 2320.

While the data processor 20 is provided with an asynchronous server 2305 so that the server 2305 instructs the data base management unit 30 to execute processings in FIG. 23, the data base management unit 30 itself may be configured as the asynchronous server 2305.

As described above, according to the present invention, it is possible to analyze multichannel data multilaterally and total data items so as to satisfy various detailed conditions.

Furthermore, according to the present invention, it is possible to simulate a cash flow by taking data properties in each group of totaled-up data into consideration.

What is claimed is:

1. A database system that manages, totals and processes data on a predetermined condition, the system comprising:
a data storage unit for storing data;
a data base management unit for managing input/output of said data to/from said data storage unit;
a data processor for controlling said data base management unit to obtain desired data from said data storage unit and process said data; and
a stored grouping function enabled to define a field value used to group said data,
wherein the data processor executes:
program code configured to enter an execution command that specifies said stored grouping function used in a data processing; and
program code configured to instruct said data base management unit to total said data according to a field value defined by said stored grouping function specified in said execution command.

2. The data base system according to claim 1, wherein said system further comprises a stored totaling function which sets both condition and method for totaling data, and said data processor executes;
program code configured to enter an execution command that is a combination of said stored functions for grouping and totaling data; and
program code configured to instruct said data base management unit to total said data on said condition and by said method for totaling data, set by said stored totaling function according to a field value defined by said stored grouping function.

3. The data base system according to claim 1, wherein said data processor further comprises an asynchronous server, and
said asynchronous server creates an SQL statement that includes procedures for using said stored grouping and totaling functions so as to instruct said data base management unit to execute said SQL statement.

4. The data base system according to claim 1, wherein said system further comprises an input device for entering information on a definition of said field value defined by said stored grouping function, and
said data processor creates an SQL statement used to create said stored grouping function according to said information entered via said input device and instruct said data base management unit to execute said created SQL statement.

5. A financial data processing system for managing financial data and analyzing said financial data on a predetermined condition, the system comprising:
a data storage unit for storing said financial data;
a data base management unit for managing input/output of said financial data to/from said data storage unit;
a data processor for controlling said data base management unit to obtain predetermined financial data from said data storage unit and process said data;
a plurality of stored grouping functions each enabled to define a field value used to group financial data respectively; and
a plurality of stored totaling functions, in each of which both condition and method for totaling financial data are set,
wherein said data processor executes:
program code configured to specify a stored grouping function selected from among said plurality of stored grouping functions to be used in a data processing and enter an execution command that specifies a stored totaling function selected from among said plurality of stored totaling functions to be used in said data processing; and
program code configured to instruct said data base management unit to total up data on said condition and by said method set by said stored totaling function according to said field value defined by said stored grouping function.

6. The financial data processing system according to claim 5, further comprising:
a first input device for entering information on the definition of said field value set by said stored grouping function; and
a second input device for entering information on said condition and said method set in said stored totaling function, and
said data processor executes:
program code configured to create an SQL statement used to create said stored grouping function according to said information entered via said first input device;
program code configured to create an SQL statement used to create said stored totaling function according to said information entered via said second input device; and program code configured to instruct said data base management unit to execute said created SQL statement.

7. A financial data processing system that manages financial data to total said financial data on a predetermined condition and calculate a cash flow according to said totaled financial data, the system comprising:
a data storage unit for storing said financial data;
a data base management unit for managing input/output of said financial data to/from said data storage unit;
a data processor for controlling said data base management unit to obtain desired financial data from said data storage unit and calculate said cash flow; and
a stored function for defining a field value used to group said financial data,
wherein said data processor corrects said calculated cash flow according to the properties of said financial data in each group defined by said field value defined by said stored function.

8. The financial data processing system according to claim 7, further comprising:
a property information input device for entering property information of said financial data according to each field value set in said stored function, and
said data processor executes:
program code configured to receive financial data property information used to correct said cash flow via said property information input device;
program code configured to receive an execution command that specifies said stored function corresponding to said financial data property information used to correct said cash flow; and
program code configured to correct said calculated cash flow according to said property information received via said property information input device and corresponding to said stored function specified in said execution command.

9. The financial data processing system according to claim 8, wherein said property information input device decides a predetermined setting period and enters said property information in each set period.

10. A data processing apparatus, comprising:
an input device for entering definition information that includes an original field expression used to group data in an analysis mother data base, definition of a new field value used to group said data newly, and a range in which said new field value is effective; and
a data processor connected to a data base management unit of said analysis mother data base and enabled to create an SQL statement used to instruct said data base management unit to create a stored function for setting a field value corresponding to said definition information in case said data base management unit extracts data according to said definition information received via said input device.

11. A data processing apparatus, the apparatus comprising:
an input device for entering definition information that includes a statistical expression used to obtain statistical information from a predetermined data group and an object field expression used to identify a group of data to be extracted; and
a data processor connected to a data base management unit of said analysis mother data base and enabled to create an SQL statement used to instruct said data base management unit to create a stored function for limiting data to be extracted when said data base management unit extracts data according to said definition information received via said input device.

12. A data processing apparatus, the apparatus comprising:
a data processor for calculating a cash flow by obtaining predetermined financial data from an analysis mother data base that stores said financial data; and
an input device for entering property information that includes a group key used to identify said financial data to be processed, a predetermined setting period, and a property of said financial data set for said group key and said setting period respectively,
wherein said data processor corrects said calculated cash flow according to said property information received via said input device.

13. A data extracting method comprising the steps of:
entering an execution command that specifies a first stored function enabled to define a field value used to group data and a second stored function enabled to set both condition and method for totaling said data;
creating an SQL statement that describes a processing for totaling data on said condition and by said method set in said second stored function according to said field value defined by said first stored function; and
instructing a data base management unit provided with said first and second stored functions to execute said created SQL statement.

14. A cash flow calculating method for managing financial data so as to total said financial data and calculate a cash flow according to said totaled financial data, comprising a steps of:
entering a cash flow calculation command that specifies a stored function enabled to define a field value used to group data and property information of said financial data set for each field value in said stored function;
calculating a cash flow according to said command; and correcting said calculated cash flow according to said property information corresponding to said stored function specified in said command.

15. A computer program product comprising a computer useable medium having computer readable code embodied therein for extracting data, the program product comprising:
program code configured to enter an execution command that specifies a first stored function enabled to define a field value used to classify data and a second stored function enabled to set both condition and method for totaling said data;
program code configured to create an SQL statement that describes a processing for totaling data on said condition and by said method set in said second stored function according to said field value defined by said first stored function; and
program code configured to instruct a data base management unit to execute said created SQL statement, said data base management unit being provided with said first and second stored functions.

16. A computer program product comprising a computer useable medium have computer readable code embodied therein for calculating a cash flow, the program product comprising:
program code configured to enter a cash flow calculation command that specifies a stored function enabled to define a field value used to classify data and property information of financial data set for each field value in said stored function;
program code configured to calculate a cash flow according to said command; and
program code configured to correct said calculated cash flow according to said property information corresponding to said stored function specified in said command.
